(19) United States
(12) Patent Application Publication
(10) Pub. No.: US 2011/0099495 A1
(43) Pub. Date: Apr. 28, 2011

(54) METHOD FOR ENABLING INTERNET ACCESS ON A MULTIFUNCTION REPROGRAPHIC MACHINE

(75) Inventor: Steven J. Harrington, Webster, NY (US)

(73) Assignee: Xerox Corporation, Norwalk, CT (US)

(21) Appl. No.: 12/603,732

(22) Filed: Oct. 22, 2009

(51) Int. Cl. G06F 3/048; G06F 15/16

(52) U.S. Cl. 715/765; 715/825; 709/206

(57) ABSTRACT

A system and method are described that enable a multifunction reprographic machine with limited display means to perform retrieval of documents or web pages by allowing a user to enter the address of a web page. The retrieved web page is examined for any links embedded in the retrieved web page and these embedded links are reformatted for the limited display and user interface and re-displayed to allow the user to further search for a desired document. When the desired document is retrieved, the user can submit the document to the multifunction reprographic machine for processing.

### BACKGROUND

The teachings provided herein are directed to a method and apparatus for enabling a net-connected multifunction device to navigate and print information available via services on the web.

The world wide web has evolved to be more than just a source of information in the form of web pages. With the extensions of hypertext markup language and web browsers to support form, applets, and scripts, a browser can provide the interface to applications that allow the user to access, enter, modify, and otherwise interact with information and the world.

One example of such is e-mail. Some conventional e-mail services provide online web access to e-mail accounts. This web access provides almost universal web access to these accounts because all the user needs is a computer with internet access. Even conventional applications that originally were accessed, via customized software, are now providing web access.

This trend can be seen in many other applications in which web pages are used to navigate to and access information. In other words, the web pages provide web-page interfaces that are intended for users and not web services. This trend should not be confused with a related trend to provide access to services via the web to programs and devices through web services.

The web page utilized as an interface offers a fairly standard paradigm where the user is presented with text and hyperlink Uniform Resource Locators (URL) or forms that generate URLs and the interaction takes the form of selecting and following a URL. The intelligence lies with the user in making the link selections.

Web services, on the other hand, can require a much greater degree of understanding and cooperation between the client program accessing the service, and the server program providing it. Furthermore, each web service is likely to define its own access semantics. Thus, a different client program may be needed for each such service.

One potentially desirable set of multifunction device services is the providing of access and printing of the information that the world wide web offers. Conventionally, a user can navigate the web, using a personal computer, and submit a selected page for printing. However, this approach breaks down if one does not have a computer handy, or is not connected to the web, or is not tied in to the printer or multifunction device.

A desirable alternative scenario would be for the user to walk up to the multifunction device, and to use it to access as well as print the desired information. For example, a user might walk up to a multifunction device, and from there select and print email messages. This could, for example, provide access from an airport or hotel. It might also be useful in the user's office; since one must to go to the multifunction device to pick up prints anyway, it might convenient to request additional documents while there.

It is common for a wide variety of multifunction devices to include the ability to access the Internet, often wirelessly. Due to market cost-constraints, many of these multifunction devices have relatively limited display capabilities compared to a personal computer display. However, users of multifunction devices with such limited display capabilities may still desire to retrieve documents over the network and to submit these retrieved documents for processing. Such processing might include printing the document, e-mailing the document, or perhaps storing the retrieved document on a server.

While the multifunction device user interface has some graphic capabilities it is typically limited in size due to cost or form factor constraints. This size limitation makes it difficult or impossible to display a retrieved document as is commonly done using a web browser on a personal computer.

Since the user interface display has graphic capabilities that are not as extensive as a normal computer display it would be desirable to condense the information on a web page to display the links on the web page that point to other web pages or directly to documents that are of interest. Furthermore, it would be desirable if such a condensed display would provide function that would allow a user to retrieve a document and forward it for further processing.

Such a system might include a user interface to accept input from a user and to display information to the user; a processor to retrieve an object from an address entered by the user via the user interface, and to extract from the retrieved object a link, and also where the processor formats the link information so that it is suitable for display on the user interface and where the processor adds a selectable user actionable area to be displayed on the user interface along with the link information.

Such a system might also include associating a user action the user actionable area and performing the user action when the user selects the displayed user actionable area on the user interface.

An example of such a user action might include submitting the retrieved document for printing or the action might include mailing the retrieved document to an e-mail address provided by the user via the user interface

The system might also extract identification information associated with the extracted link and display the identification information.

The system might include grouping a plurality of extracted links into group, where the identity of the groups is defined by a web page context and then displaying the group information. The web page context might include a web-based e-mail context. The web context might be specified by the way in which the system is invoked, or it might be defined by information contained in the retrieved object.

### BRIEF DESCRIPTION OF THE DRAWING

The drawings are only for purposes of illustrating various embodiments and are not to be construed as limiting, wherein:

FIG. 1 illustrates a block diagram of a system that enables retrieval and processing of a remote document by a multifunction reprographic machine or device;

FIG. 2 illustrates a sample of a user interface display for a retrieved document;

FIG. 3 illustrates a web page for an e-mail system where links on the web page are identified;

FIG. 4 illustrates a sample of a user interface display where the links on a retrieved web page are grouped and the group identifications are displayed;

FIG. 5 illustrates a sample of a user interface display after a group of links has been selected; and

FIGS. 6 and 7 illustrate a flowchart of a method that enables a multifunction reprographic machine or device to retrieve and process remote web pages.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

As noted above, it is desirable to provide a set of services for a multifunction device with respect to accessing and printing information found on the world wide web. However, while one can readily navigate the web on a personal computer, such navigation is considerably more difficult on a multifunction device with its inherently more limited display capability.

One solution to the issues associated with accessing and printing information found on the world wide web is to provide the user with web browser access at the multifunction device. The web-page interface is used by the user to navigate to the desired document. However, the conventional device user interface provided on a multifunction device is not powerful enough to support such arbitrary web browsing. There are also the issues of integration between the browsing and the device control. Thus, it is desirable to provide an interface that addresses these issues.

As will be described in more detail below, a conversion process takes conventional web pages and derives, from the conventional web pages, a user interface (UI) page suitable for display on the multifunction device display.

In one embodiment of this conversion process, images and most text from the web page can be discarded and only the hyperlinks are retained. The hyperlink text is arranged in a table format for the user interface to display, enabling the user to select a link to follow and choose either to print the returned page or to display further revealed links on the user interface display.

Simply displaying just the hyperlinks at the user interface may be problematic for general browsing; however, displaying the hyperlinks at the user interface may be sufficient when displaying the web pages intended for navigating to desired information such as the pages of an e-mail application intended for selection and display from a user's inbox of messages. However, the construction of a single table of all hyperlinks may not be suitable in all situations because some web pages can contain several sets of links intended for different proposes.

For example, an e-mail navigation page might contain hyperlinks to the messages in the user's inbox in addition to links to other e-mail directories, links to the home page of the service, links to legal notices, links to other services offered to the user, links to advertisements, etc.

The web page may also have some structure. The web page may be organized into frames, tables, lists, and forms. This page structure can be used to group the hyperlinks. A user interface page may be presented with a table of groups, allowing the user to select the group of interest. If the web page contains a caption or other text that labels the structure defining a group of links, this text can be used to describe the group on the user interface page. Otherwise, a label can be constructed from the text associated with the individual links in the group.

If there is only one group of links for a web page, or if it is known in advance which group of links is the one appropriate to the service being provided by the multifunction device, the presentation of the user interface page for group selection may be skipped, and the user interface page for the hyperlinks of the known desired group may be directly presented.

For example, if the e-mail web page has six groups of hyperlinks and the fourth group contains the links for the messages in the inbox, an email printing application on the multifunction device can use this information to directly display the fourth group of hyperlinks when an e-mail web page is accessed.

The description herein refers to the retrieval of a web page over a computer network. In the description herein, the term “web page” is defined to mean either an actual web page as is typically retrieved and displayed by a conventional web browser, or in the alternative, the term “web page” may refer to a document that is located by a specific uniform resource locator (URL) the common term for the address of an object on the internet.

As set forth below, the networked devices have a user interface on a display, which are smaller in the displayable area and less capable than the user interface and display of a conventional personal computer. Thus, input area associated with the user interface may be just a few buttons or perhaps provided for by a touch screen capability rather than a full keyboard. Examples of such multifunction devices would include wireless devices with a display screen or networked multifunction reprographic machines. As will be appreciated by those skilled in the art other examples of such devices are known and contemplated herein.

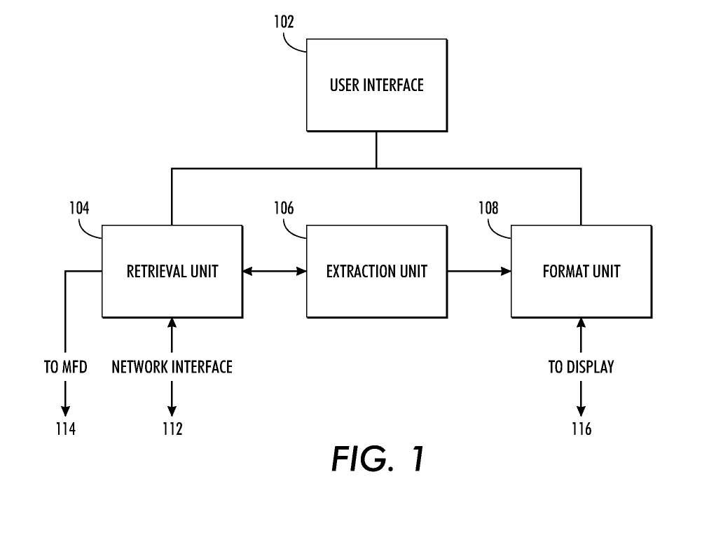

FIG. 1 shows a block diagram of a system, which is part of a multifunction device and allows a user to retrieve a web page and select links on that web page for further action using only the multifunction device's user interface.

FIG. 1 illustrates a display unit 108 and retrieval unit 104 as being directly connected to a user interface 102; however, as will be appreciated by those skilled in the art, the user interface 102 may be part of the underlying multifunction device and the actual connections between the display unit 108 and retrieval unit 104 and the user interface 102 are mediated by the control system of the multifunction device.

The system described below may be integrated into the control system of the device. Alternatively, the system described here may be provided as a separate entity that is interfaced to the multifunction device.

Operation of the system in FIG. 1 begins when a user selects the retrieval mode using the user interface 102 and enters an address; e.g., the URL of a web page which the user wishes to access. The web page located at the address might contain content that the user is interested in, or the web page may further contain one or more links to other web pages that the user wishes to access. The user interface 102 may include a separate keyboard for entry, or the user interface 102 may include a combination; such as displaying a keyboard on the user interface display and using a touch screen capability of the display to enable entry of the URL. Other entry devices, such as a mouse or trackball, are also well known by those skilled in the art and may be used as well.

The URL entered by the user is sent to the retrieval unit 104. The retrieval unit 104 formats a request for the web page at the supplied URL and sends the request via the network interface 112 over the network to the device resource that contains the desired web page. The retrieval unit 104 may access the network interface 112 directly, or more commonly, the retrieval unit 104 may use the network interface 112 and network protocol mechanisms that are part of the multifunction device.

When the web page is returned to the retrieval unit 104 via the network interface 112, in one embodiment, the web page is passed to the extraction unit 106. The extraction unit 106 scans the content of the retrieved web page and identifies any links embedded in the web page.

This extraction is enabled by the coding of web pages in the hypertext markup language including specific markers that identify links. Furthermore, while many web pages do not directly display the link, which is conventionally the URL of another web page, but instead display information that describes the link, such descriptive information is typically included as part of the hypertext markup language that the retrieval unit 104 utilizes for recognizing a link embedded in a web page.

The extraction unit 106 identifies such descriptive text along with the associated link URL if the descriptive text exists. When the extraction unit 106 completes the scan, the extraction unit 106 passes a list of link-description pairs to the format unit 108. The format unit 108 accepts the list of link-description pairs and reformats the document so that just the link-description pairs are displayed on the user interface 102. The reformatting of the list may include adding an actionable area to the reformatted document for each link-description pair where the actionable area defines a user action associated with the link-description pair.

An example of an actionable area may include defining a location on the user interface where the user can select to initiate processing the web page associated with the selected link-description pair. Such processing might include retrieving the web page associated with the link-description pair for printing or storage, or the processing may include options that send the web page to for processing some other device.

In addition to a user actionable area associated with a link-description pair, the extraction unit 106 may add other user actionable areas to be added by the display unit 108 and displayed by the user interface. Such other actionable areas may include a user action that could select sending the currently retrieved web page to a printer or an e-mail system. Another actionable area might allow a user to submit a selected link to the retrieval unit 104 to continue retrieving web pages until a desired web page is retrieved.

When the format unit 108 has completed its processing, the format unit 108 sends the reformatted document to the display part of the user interface 116 to allow further action by the user.

The preceding sequence of operations may be repeated as many times as necessary to allow the user to reach a web page that contains information the user is looking for. If, for example, the user action is to retrieve the web page pointed to by a link displayed on the user interface, the link will be returned to the retrieval unit for retrieval.

Eventually, the user will find the web page that the user is looking for and choose the user action that performs the desired processing. Alternatively, the user action may include simply displaying the retrieved web page on the display, if the web page content is within the display capabilities of the user interface.

The submission of a retrieved web page for further processing may result in transmitting the web page to another device on the network. Such a device may be a printer or a server that can store the web page. Alternatively, the system described above may be included as part of a more extensive device such as a networked multifunction reprographic device.

Processing by a networked multifunction device can include any of the functions that the multifunction device is capable of that are relevant to the web page that has been retrieved. These may include: printing the web page, storing the web page for later access, e-mailing the web page to an address supplied by the user, or transmitting the document, via FAX, if the multifunction device includes a FAX connection.

As described above, the extraction unit 106 may use the structure provided by the hypertext markup language that is used to encode web pages to help extract the links. An implementation would search the document for the specific tags that identify a link. A typical link might be encoded as:
<a href=http://www.dewshields.com/programs.html>Freeware Astronomy Downloads</a>

Where the “<a href=http://www.dewshields.com/programs.html>” part defines the URL of the web page being linked to, but which is not displayed, and instead only the “Freeware Astronomy Downloads” text is normally displayed, usually in a separate color or underlined or distinguished from normal text in some way. The “</a>” part is a closing tag for the link. Searching a document to identify parts that are formatted according to hypertext markup language rules as exemplified by the link above is well known.

The units identified in FIG. 1, as will be well understood by those skilled in the art, may be implemented by a microprocessor programmed to carry out the various search functions together with some hardware elements that interface the microprocessor to the multifunction device's parts. The units may also be implemented as one or more customized ASIC devices, designed to carry out the functions of one or more of the units identified in FIG. 1. Another implementation could add the functions of one or more of the units identified in FIG. 1 as a set of instructions that are stored as part of the instructions for the control processor of another device.

In an alternative embodiment, a hypertext markup language to internal device control converter is invoked from a servlet for the application that is registered at the multifunction device. The user selects a URL at the multifunction device (such as by selecting a table entry on a user interface page), and this URL is send to the servlet as data. The servlet then passes the URL to the hypertext markup language to internal device control converter. The converter includes at least two stages.

The first stage is performed by a hypertext markup language client that acts like a browser for retrieving the web page addressed by the URL. This client deals with the retrieval of referenced files, the execution of JavaScript function, and other such browser operations that go into retrieval of the page. The hypertext markup language client does not display the page, but rather, creates a document object model, which is a representation of the page. This document object model becomes the input to the second stage that extracts the groups of hyperlinks.

In one embodiment, this second stage is in turn executed in two steps. The first step is to analyze the tree of nodes that form the document object model representation of the page and to identify the structure elements (frames, table, lists, rows, and so on) as well as the hyperlinks (anchors). The second step is to analyze the extracted structure information to determine which hyperlinks should be grouped together. The resulting groups of links are used to construct user interface pages that the servlet provides to the multifunction device. The construction of the user interface page from the list of hyperlinks can be included as part of the converter, or, in the alternative it can be done by the servlet.

The converter may use the text associated with the hyperlink in the web page as the text to display in the table of the user interface page. If this text is too long, it is truncated to fit within the user interface table. However, sometimes a web page may contain other text near the hyperlink that might be included at the user interface.

For example, a web page for the user's email inbox may show the message title as a hyperlink, but it may also show the message sender and date as non-hyperlinked text. This text may be included in the same table row or list item as the hyperlinked text. The structure and link extraction step can identify text that is in the same table row or list element as a hyperlink and combine that text with the hyperlink text to make a more complete entry for the user interface table.

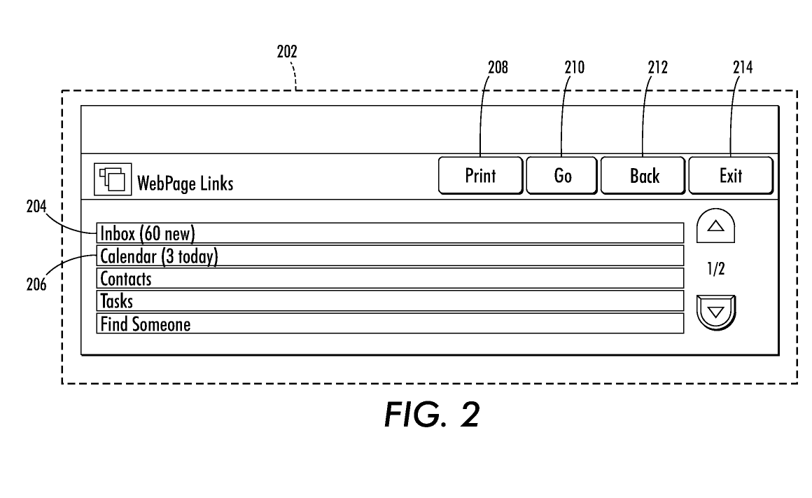

FIG. 2 shows an example of a display of a set of web page links. In this embodiment, such a display includes a modest resolution monochrome display wherein the display surface also functions as a touch screen input device. Other display devices may also be used, such as a video screen display. Similarly, input methods other than touch screen, such as a keyboard or mouse might be used.

As illustrated in FIG. 2, the web page chosen by the user is that of a web-based e-mail system. The display 202 includes a variety of links on the page. For example, item 204 is a pointer to the inbox of the e-mail system while item 206 is a pointer to the calendar part of the e-mail system. Similarly the other displayed items point to other parts of the web based e-mail system such as, “Contacts,” “Tasks,” and “Find Someone.”

FIG. 2 further includes a set of user selectable actions, 208, 210, 212, and 214. These actions are not related to the content of the web page but instead allow the user to direct the overall retrieval operation. The options shown in FIG. 2 include: print the currently retrieved web page 208; follow the currently selected link, 210, go back to the previously retrieved web page 212; or exit the retrieval process 214.

However, web pages are often more structurally complicated than simple text with links embedded in the web page. Various other structures may be defined in the hypertext markup language specification, such as frames or tables. A more complex set of extraction rules are established to identify such structure within a given web page. Such structure may be used to organize the displayed links on the user interface in a way that reflects that structure. By doing so, the displayed information may assist the user in readily identifying a particular link.

Such an implementation could further take advantage of the structure imposed on a web page as defined by the specific application the web page is associated with. One example of such an association is the set of links associated with a given web page, as located within and part of a network-enabled e-mail access system. The system may be aware of the specific context for the web page: which for this example includes only access to an e-mail system. This context defines a set of rules describing how the links on the page are grouped into related sets. Since the system being accessed may group the links according to some predefined set of rules or distinct patterns, well known techniques can be used to extract of each group of links separately.

A first option that the extraction unit 106 may present to the user would be to select which group of links should be displayed in more detail. For example, if the user chose to display the e-mail links, the extraction unit 106 would display the links to the individual e-mail messages. This would allow a user to select a particular e-mail and print the e-mail or otherwise further process the particular e-mail.

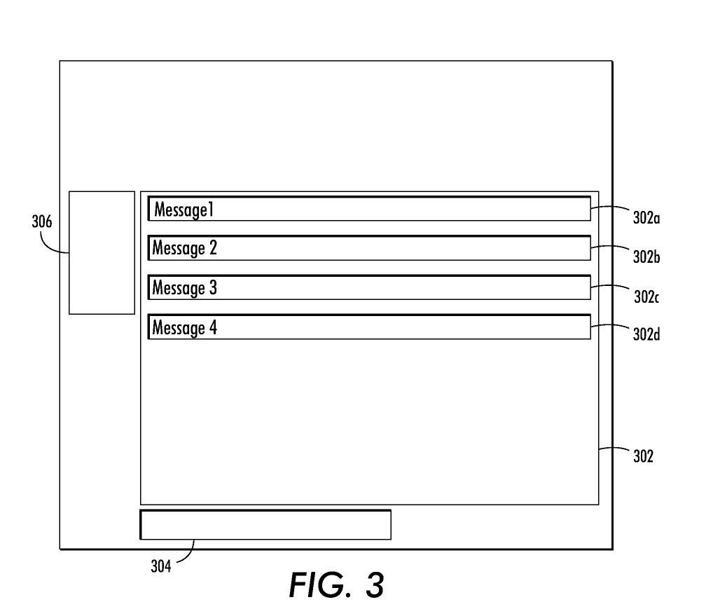

FIG. 3 shows in schematic form a web page that is typical of an e-mail system. The web page is divided into many separate sections that group similar functions. For example, area 302 is a sub-window that holds links to individual e-mail messages, indicated by items 302a, 302b, 302c, and 302d. There is a group of links area 304 underneath the e-mail links sub-window that provides options to process individual e-mail messages. These links may include options to delete a selected set of messages or to reply to a selected message or other options that are well known.

FIG. 3 also shows a group of links area 306 that enable the user to access various parts of the e-mail system such as the “Inbox” or the “Sent Mail” collection as well as others. There may be other groups of links as well.

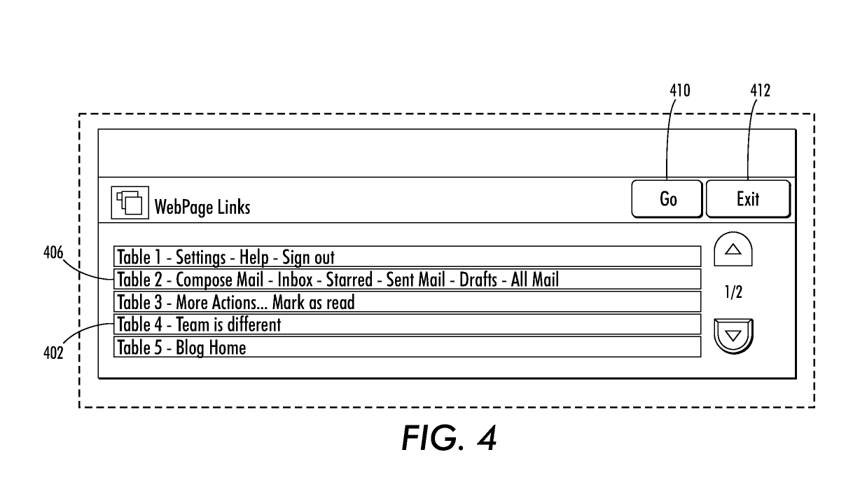

FIG. 4 shows an embodiment of how the set of links in FIG. 2 might be displayed when the specific context information is added. In FIG. 4, the links have been grouped into several sets, labeled Table 1 through Table 5, each table corresponding to a separate part of the source web-based e-mail page.

For example, item 406 allows the user to select from the group of links that correspond to the group of links 306 in FIG. 3, allowing the user to access one of the specific collections, such as the Sent Mail or Inbox of the e-mail application. Display item 402 indicates a link to a specific e-mail message. Also, in FIG. 4, the user actions are limited to just two: either to go 410 to the selected group, or to exit 412 the retrieval process.

By selecting one of the groups displayed in FIG. 4 (tables 1-5), the user can access a more detailed set of links corresponding to the part of the e-mail system that the user wishes to access. The grouping arrangement may help to identify those links that are more likely to of interest to the user in this kind of access, as opposed to the links that might be of interest if the user were to access the web page using a full-featured web browser.

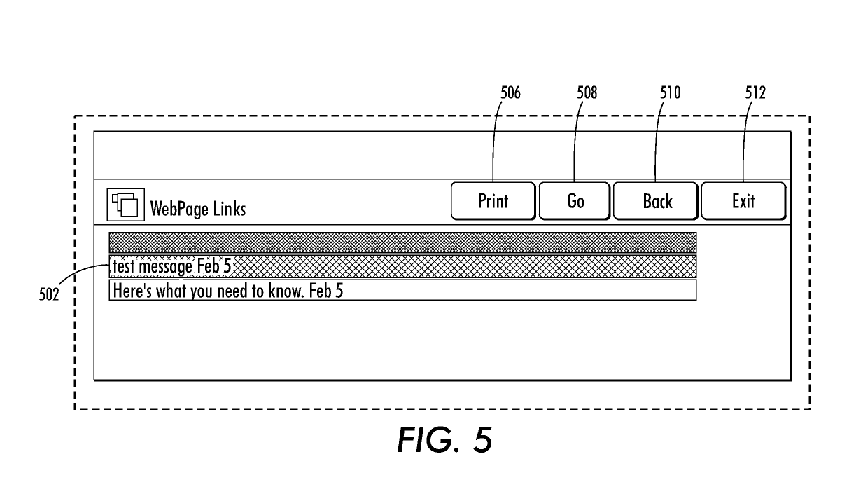

FIG. 5 shows a display that might be shown if a user selected the link displayed as item 406 in FIG. 4. As illustrated in FIG. 5, the header of the selected e-mail message 502 is shown. The group of user actions 506-512 includes a set of user input actions that might be associated with this e-mail link.

These actions include: user input action 506 which submits the selected e-mail message content to the multifunction device for printing; user input action 508 that allows the user to retrieve the content of the message for display viewing; user input action 510 to go back to the previous display page; or user input action 512 to exit the entire application.

An alternative embodiment may embed much or all of the function of the system described above as part of the instruction set of the control unit in the networked multifunction device. The control unit is often built around a microprocessor system. By adding some combination of software and possibly some hardware elements, the control unit can carry out the functions previously described above.

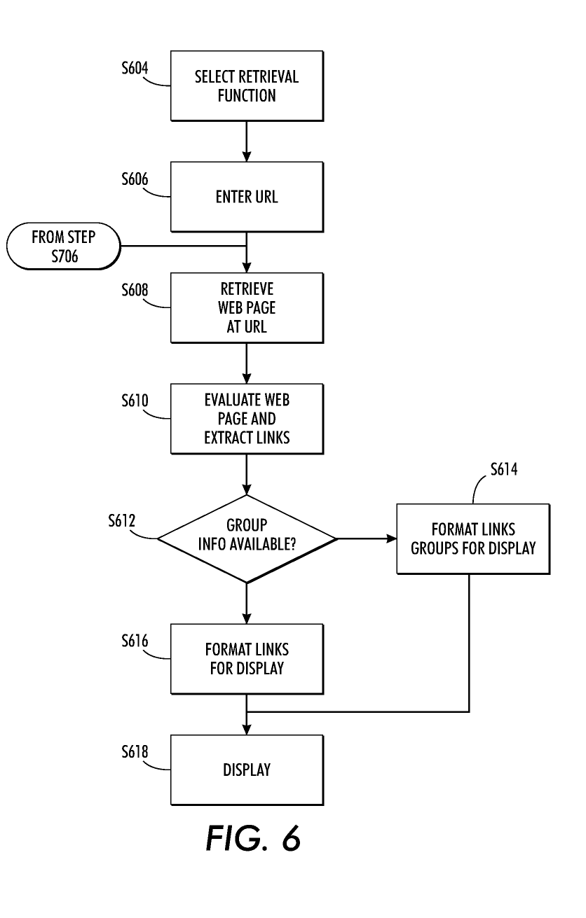

FIG. 6 shows, in flowchart form, a method that enables a multifunction reprographic machine or device to retrieve and process remote web pages. In step S604, a user selects the document retrieval function on the user interface. In step S606, the user enters the URL of a web page to be retrieved. The URL is then used, in step S608, to retrieve the addressed web page. The retrieval process requires formatting a proper request for the web page, sending the request to the user supplied URL, negotiating any communication setup and overhead and receiving and saving the requested web page content.

In step S610, the retrieved web page is evaluated to extract the links from the web page. The extraction process may simply extract the links by locating any link tags embedded in the web page. Each extracted link is examined to identify any associated display information that is displayed on the web page instead of the actual link details.

In step S612, the extraction stage checks to see if the group of links can be identified. The grouping of links may be done by using the structure of the web page that may be identified by the computer language used to specify the web page, or by other means.

For example, links that are organized as a table on the web page may be identified by language elements that specifically identify a table. Alternatively, the grouping information may be obtained by identifying the specific context of the web page. Such specific context could be identified by matching the URL to a list of pre-defined and stored URLs, or by noting the way in which the process was invoked. For example, the options on the user interface might include a specific option to request a web page from an e-mail web site.

The extracted links or link groups are processed in a display formatting step. In step S614, link groups are formatted rather than individual links. In step S616, the actual link information is formatted for display. In these steps, the link and display information is formatted so that the link may be displayed on the user interface of the multifunction device on which this process is operating.

The display formatting step may also include the addition of user action input action options to the displayed information. User input action options include ways to select a link or link group. Further user input actions might include an option to submit the web page associated with a link for processing by the multifunction device that the process is operating on, to submit the retrieved web page to another networked device, or an option to select a link and repeat the process using the selected link as a new web page address, or other actions as may be appropriate. Finally, in step S618, the formatted information is shown on the user interface display unit 108 of the multifunction device.

After step S618, the formatted information is now displayed on the user interface of the multifunction device and the process waits for a user response. The user response is indicated by having the user make a selection using one of the input means of the user interface. The possible user responses are indicated by the user input action options on the displayed information. The input mechanism might include touching a particular area of the user interface display, or perhaps pressing one or more buttons on the user interface.

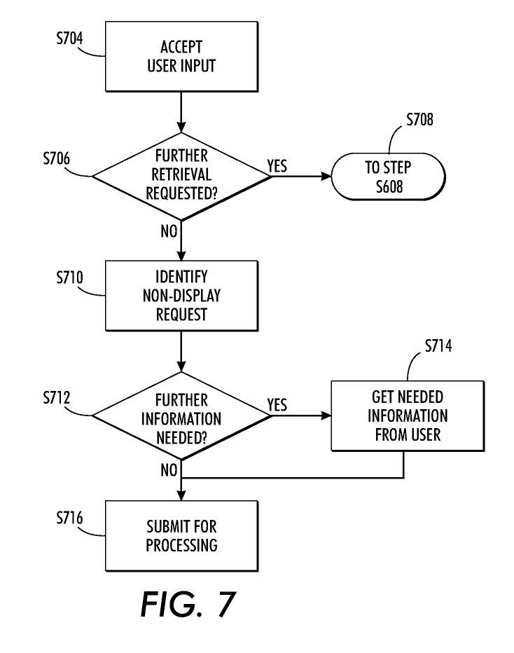

FIG. 7 shows another part of the method illustrated in FIG. 6. After invoking the method shown in FIG. 6, in step S704, the process waits for a user input. The user input may involve selecting one of the links or link groups that were displayed. Alternatively, the user input may involve some other action.

In step S706, a check is made to see if a further retrieval is requested. The user request may be to retrieve and display the selected link, or the request may be a non-display request. For example, the user might select a link and request that the referenced item be printed. In such a case no display is necessary and the process can continue at step S710. If the request is to display the item referenced by the selected link, control transfers, in step S708, back to step S608 of FIG. 6, using the selected link as the new URL for the retrieval part of the process.

In step S710, the specific request type of non-display request is identified. An example of a type of non-display request would be a request to fetch and submit the referenced web page to a printer. Another example of a non-display request is a request to e-mail the current web page to a remote mail address. Each non-display request may require additional information.

In step S712, the identified request type is used to determine if any additional information is needed from the user. An example of such information may be the address to send or e-mail the currently retrieved web page to.

If further information is needed, in step S714, the information is obtained from the user via the user interface. Finally the web page is submitted, in step S716, for the processing required to carry out the request.

For example, if the request is to print the current document then the address of a printer is required. However, if, for example, the process being described is implemented on a networked multifunction device then no address may be needed since the device itself can print the web page. However, before printing the document, in such a case the process first checks to see if the printing is to be done on the local device or a remote printer. If it is to be done on a remote printer then the address of the remote printer is obtained from the user.

The system and method described herein may be implemented in numerous different ways. The system may be implemented as a separate mechanism that is attached to another networked device or the method may be implemented as computer instructions to a control computer for a networked device.

An example of a separate mechanism would be to implement the system as a module that is interfaced to an existing networked multifunction reprographic machine. The module could use the user interface of the multifunction reprographic device or it could provide its own separate user interface.

In another embodiment the system could be implemented on a portable device such as a wireless phone. If implemented on a portable device the system would be a set of instructions for the control computer of the portable device.

In summary, a system to enable processing of remote documents by a multifunction reprographic device includes a user interface to accept input from a user and to display information to the user and a processor to retrieve an object from an address on a computer network, the address being entered by the user via the user interface. The processor extracts from the retrieved object a referencing link; formats the link information so that the link information is suitable for display on the user interface; causes a selectable user actionable area to be displayed on the user interface, the selectable user actionable area being associated with the link information; and performs a user action associated with the user actionable area when the user selects the displayed user actionable area on the user interface.

The user action associated with the user actionable area may comprise submitting the referenced document for printing. The selection of the actionable user area may mail the referenced document to an e-mail address provided by the user via the user interface.

The processor may group a plurality of extracted links, an identity of the group being defined by information contained in the retrieved object, the processor causing the user interface to display information about the group of extracted links.

The processor may extract identification information associated with an extracted link and causes a display of the identification information instead of the link or may specify a web context, the web context enabling the processor to group extracted links into a group, an identity of the group being defined by the web page context, the processor causing the displaying of information about the group of links. The processor may identify the specific web context by identifying how the system is invoked or may identify information in the retrieved document that identifies a group of links, wherein the processor causes the displaying of information about the group of links.

The specific web context may include a web-based e-mail context.

A method to enable processing of remote documents by a multifunction reprographic machine provides a user interface to accept input from a user and to display information to a user; retrieves, using a processor, an object associated with a remote address inputted by the user through the user interface; extracts, using a processor, from the retrieved object a referencing link, the link being the address of another remote object; reformats the retrieved object to display only the extracted link on the user interface; and displays the reformatted object on the user interface.

The method may reformat the retrieved object by adding a user action area associated with a user action. The user action may submit the referenced document for printing; submit the referenced document for mailing to an e-mail address provided via the user interface; submit the referenced document for storage on a server; or retrieve the document addressed by the link associated with the user actionable area.

The method may extract from the retrieved object by extracting identification information associated with each extracted link and wherein the displaying of the reformatted object displays the identification information instead of the link.

The method may use information specifying a specific context, the specific context enabling the extracting from the retrieved object to group extracted links, an identity of the group being defined by the specific context and wherein the reformatted document includes displaying information about the groups of link. The method may use information contained within the retrieved document that identifies groups of links and wherein the reformatted document includes displaying information about the groups of links.

The specific context may include an e-mail context. The method may specify a specific context by identifying the specific context by identifying how the method is invoked.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system to enable processing of remote documents by a multifunction reprographic device, comprising:
a user interface to accept input from a user and to display information to the user; and
a processor to retrieve an object from an address on a computer network, the address being entered by the user via the user interface;
said processor extracting from the retrieved object a referencing link;
said processor formatting the link information so that the link information is suitable for display on the user interface;
said processor causing a selectable user actionable area to be displayed on the user interface, said selectable user actionable area being associated with the link information;
said processor performing a user action associated with the user actionable area when the user selects the displayed user actionable area on the user interface.

2. The system of claim 1 wherein the user action associated with the user actionable area comprises submitting the referenced document for printing.

3. The system of claim 1 wherein said processor groups a plurality of extracted links, an identity of the group being defined by information contained in the retrieved object, said processor causing said user interface to display information about the group of extracted links.

4. The system of claim 1 wherein the selection of the actionable user area mails the referenced document to an e-mail address provided by the user via the user interface.

5. The system of claim 1 wherein said processor extracts identification information associated with an extracted link and causes a display of the identification information instead of the link.

6. The system of claim 1 where said processor specifies a web context, the web context enabling said processor to group extracted links into a group, an identity of the group being defined by the web page context, said processor causing the displaying of information about the group of links.

7. The system of claim 6 wherein the specific web context includes a web-based e-mail context.

8. The system of claim 6 wherein said processor identifies the specific web context by identifying how the system is invoked.

9. The system of claim 1 wherein said processor identifies information in the retrieved document that identifies a group of links, and wherein said processor causing the displaying of information about the group of links.

10. A method to enable processing of remote documents by a multifunction reprographic machine comprising:
providing a user interface to accept input from a user and to display information to a user;
retrieving, using a processor, an object associated with a remote address inputted by the user through the user interface;
extracting, using a processor, from the retrieved object a referencing link, the link being the address of another remote object;
reformatting the retrieved object to display only the extracted link on the user interface; and
displaying the reformatted object on the user interface.

11. The method of claim 10 wherein the reformatting of the retrieved object further comprises adding a user action area associated with a user action.

12. The method of claim 11 wherein the user action submits the referenced document for printing.

13. The method of claim 11 wherein the user action submits the referenced document for mailing to an e-mail address provided via the user interface.

14. The method of claim 11 wherein the user action submits the referenced document for storage on a server.

15. The method of claim 11 wherein the user action retrieves the document addressed by the link associated with the user actionable area.

16. The method of claim 10 wherein the extracting from the retrieved object further comprises extracting identification information associated with each extracted link and wherein the displaying of the reformatted object further comprises displaying the identification information instead of the link.

17. The method of claim 10 where the extracting from the retrieved object uses information specifying a specific context, the specific context enabling the extracting from the retrieved object to group extracted links, an identity of the group being defined by the specific context and wherein the reformatted document includes displaying information about the groups of link.

18. The method of claim 17 wherein the specific context comprises an e-mail context.

19. The method of claim 17 wherein the specifying a specific context comprises identifying the specific context by identifying how the method is invoked.

20. The method of claim 10 wherein the extracting from the retrieved object uses information contained within the retrieved document that identifies groups of links and wherein the reformatted document includes displaying information about the groups of links.
